(19) United States
(12) Patent Application Publication
(10) Pub. No.: US 2016/0372984 A1
(43) Pub. Date: Dec. 22, 2016

(54) Stator

(71) Applicant: Bose Corporation, Framingham, MA (US)

(72) Inventor: Robert P. Parker, Westborough, MA (US)

(21) Appl. No.: 15/176,886

(22) Filed: Jun. 8, 2016

Related U.S. Application Data
(60) Provisional application No. 62/181,829, filed on Jun. 19, 2015.

(51) Int. Cl. H02K 3/18; H02K 1/16; H02K 1/14

(52) U.S. Cl. CPC H02K 3/18; H02K 1/14; H02K 1/16

(57) ABSTRACT

A stator for a stator-wound electrical motor, with a stator ring with an inside diameter (ID), and a series of spaced, inwardly-directed stator teeth with slots between adjacent teeth. The teeth and slots are arranged around the ID of the stator ring. At least some of the slots are inwardly tapered. There are a number of electrical coils that are partially located in the slots, where at least some of the coils surround a single tooth and occupy some of the space of both slots that border the single tooth such that in at least some of the slots there are portions of two adjacent coils. These two adjacent coils are constructed and arranged such that in order to insert both such adjacent coils on their teeth without altering either coil, one particular coil of the two adjacent coils must be inserted before the other coil.

### CROSS-REFERENCE TO RELATED APPLICATION

This application claims priority of Provisional Patent Application 62/181,829, filed on Jun. 19, 2015, the disclosure of which is incorporated herein by reference.

### BACKGROUND

This disclosure relates to a stator for electrical motors.

Many electrical motors have windings on the stator of the motor, instead of having windings on the rotor. For such stator-wound motors, the stators are typically made of laminations of steel, chosen to provide a magnetic flux path cost effectively. For rotary motors, around the inside diameter of the stator there are typically inwardly-directed alternating steel teeth to carry flux and slots into which the wire is placed. In general, power which is dissipated in the wire in the slots is minimized by putting as much wire as is practical in the slots. Minimizing this dissipated power can be advantageous to avoid overheating the motor, and it can reduce the total electrical input power requirement for providing torque or mechanical power at the motor shaft.

The steel teeth are typically either approximately rectangular or else approximately rectangular with appendages on the side of the tooth nearest the rotor, referred to sometimes as “shoes.” Although the shoes help with certain performance attributes of the motor, they make the job of winding the stator more complicated. This is because all of the wire that ends up in the slot must be led in through the small gap between adjacent shoes. In many cases the wire is wound such that it is not well ordered within the slot. Poorly ordered windings are unfavorable when the goal is maximizing the total volume of wire contained within the slots.

Coils used with motors having stator teeth without shoes are easier to wind than coils for motors having stator teeth with shoes. No shoes allows the use of bobbins. Coils can be wound separately onto bobbins, and then the bobbins can be slid onto the teeth. Or, coils without bobbins, which have been wound, formed, and secured to hold their shape, can be used. These techniques allow for ordered winding, which can increase the volume of conductor within the slots due to the known placement of each strand. However, for rectangular teeth, the slots are tapered, being wider nearer the outside diameter of the stator and narrower towards the inside diameter of the stator closer to the rotor location. The formed coil cannot be wider than the slot width at its narrowest dimension, otherwise it could not be inserted onto the tooth. This constraint typically implies that a significant portion of the slot area has no wire in it.

### SUMMARY

All examples and features mentioned below can be combined in any technically possible way.

In one aspect, a stator for a stator-wound electrical motor includes a stator ring having an inside diameter (ID) and an outside diameter (OD), the stator ring comprising a series of spaced, inwardly-directed stator teeth, and inter-tooth slots between adjacent teeth, where the teeth and slots are arranged around the ID of the stator ring, and where at least some of the slots are inwardly tapered, such that the tapered slots are wider nearer the stator ring OD than they are nearer the stator ring ID, and a plurality of electrical coils that are partially located in the slots, where at least some of the coils surround a single tooth and occupy some of the space of both slots that border the single tooth such that in at least one of the tapered slots there are portions of two adjacent coils, and where these two adjacent coils are constructed and arranged such that in order to insert both such adjacent coils on their teeth without altering either coil, one particular coil of the two adjacent coils must be inserted before the other coil.

Embodiments may include one of the following features, or any combination thereof. The two adjacent coils may be constructed and arranged such that the dimension of the greatest height of one of the two adjacent coils in the tapered slot plus the dimension of the greatest height of the other of the two adjacent coils in the tapered slot is greater than the dimension of the width of the tapered slot nearest the stator ring ID. In one non-limiting example of the present disclosure, the portion of one of the two adjacent coils in a particular slot has a generally rectangular cross-sectional shape, and the portion of the other of the two adjacent coils in the particular slot has a generally trapezoidal cross-sectional shape. The portion of the other of the two adjacent coils in the particular slot may that has a generally trapezoidal cross-sectional shape may have a greater height closer to the stator ring OD than it does closer to the stator ring ID. In another non-limiting example of the present disclosure, each of the two adjacent coils occupies about the same amount of volume in a particular slot as the other and/or each of the two adjacent coils comprises about the same number of turns of wire as the other.

Embodiments may include one of the following features, or any combination thereof. At least some of the coils may be wound on bobbins, and wherein at least one such bobbin comprises a lower wall on which the coil wire is wound, and one or more short dividers that project upwardly from the lower wall, where the short dividers have a height that is less than the wire diameter, and serve to separate wires that are adjacent to such dividers, so as to allow overlying wires to sit closer to the bobbin lower wall than they would if such wires were orthocyclically wound. The short dividers may be vertical. Also, at least a first coil may have a generally rectangular cross-sectional shape with four sides, where first and second generally parallel sides lie in two adjacent slots and third and fourth generally parallel sides do not lie in slots, and where the first coil comprises at least two layers of wire, wherein on one of the third and fourth sides the wires of adjacent layers crossover one another such that the height of the coil on that side is equal to the wire diameter times the number of wire layers, and wherein on each of the other three sides the wires of adjacent layers are generally parallel and the height of the coil on these sides is less than the wire diameter times the number of wire layers.

Embodiments may include one of the following features, or any combination thereof. The portion of one of the two adjacent coils in a particular slot may have a generally domed cross-sectional shape, and the portion of the other of the two adjacent coils in the particular slot may have a generally trapezoidal cross-sectional shape. The portion of the one of the two adjacent coils in the particular slot that has a generally domed cross-sectional shape may have a greater height closer to the stator ring OD than it does closer to the stator ring ID. The portion of the other of the two adjacent coils in the particular slot that has a generally trapezoidal cross-sectional shape may have a greater height closer to the stator ring ID than it does closer to the stator ring OD.

Embodiments may include one of the following features, or any combination thereof. The two adjacent coils may be further constructed and arranged such that their free edges that face one another in a slot are generally complementary, for example they may be generally parallel. The free edges of the coils may be generally straight, or may be curved. In at least some of the coils there may be multiple layers of wires that have a length in each layer, with a first layer closest to a stator tooth and a second layer directly on top of the first layer, where at least some adjacent wires in the first layer may be spaced apart and so do not touch one another over at least some of the length in the first layer. Also, at least some adjacent wires in the second layer may be spaced apart and so do not touch one another over at least some of the length in the second layer.

In another aspect, a stator for a stator-wound electrical motor includes a stator ring having an inside diameter (ID) and an outside diameter (OD), and a stator ring comprising a series of spaced, inwardly-directed stator teeth, and inter-tooth slots between adjacent teeth, where the teeth and slots are arranged around the ID of the stator ring. At least some of the slots are inwardly tapered, such that the tapered slots are wider nearer the stator ring OD than they are nearer the stator ring ID. There are a plurality of electrical coils that are partially located in the slots, where at least some of the coils surround a single tooth and occupy some of the space of both slots that border the single tooth such that in at least some of the tapered slots there are portions of two adjacent coils. These two adjacent coils are constructed and arranged such that the dimension of the greatest height of the part of one of the two adjacent coils that is in the tapered slot plus the dimension of the greatest height of the part of the other of the two adjacent coils that is in the tapered slot, is greater than the dimension of the width of the tapered slot nearest the stator ring ID.

In another aspect, a stator for a stator-wound electrical motor includes a stator ring having an inside diameter (ID) and an outside diameter (OD), the stator ring comprising a series of spaced, inwardly-directed stator teeth, and inter-tooth slots between adjacent teeth, where the teeth and slots are arranged around the ID of the stator ring, and where at least some of the slots are inwardly tapered such that the tapered slots are wider nearer the stator ring OD than they are nearer the stator ring ID. There are a plurality of electrical coils that are partially located in the slots, where at least some of the coils surround a single tooth and occupy some of the space of both slots that border the single tooth such that in at least some of the tapered slots there are portions of two adjacent coils. At least some of the coils are wound on bobbins, and at least one such bobbin comprises a lower wall on which the coil wire is wound, and one or more short dividers that project upwardly from the lower wall, where the short dividers have a height that is less than the wire diameter and serve to separate wires that are adjacent to such dividers so as to allow overlying wires to sit closer to the bobbin lower wall than they would if such wires were orthocyclically wound. The short dividers may be generally vertical. The two adjacent coils may be constructed and arranged such that the dimension of the greatest height of the part of one of the two adjacent coils that is in the tapered slot plus the dimension of the greatest height of the part of the other of the two adjacent coils that is in the same tapered slot, is greater than the dimension of the width of the tapered slot nearest the stator ring ID.

### BRIEF DESCRIPTION OF THE DRAWINGS

FIG. 1 is a schematic, partial, cross sectional view of a stator for a stator-wound electrical motor.

FIG. 2 is a similar view but showing different coil configurations.

FIG. 3 is also similar view, showing a particular coil configuration.

FIGS. 4A and 4B are each cross-sectional views of two bobbins in a stator slot. FIG. 4A illustrates coils wound according to the prior art, while FIG. 4B illustrates coils wound according to an example of the present disclosure.

FIG. 5 is similar to FIG. 4B but illustrating different bobbin and coil winding configurations.

FIG. 6 is a perspective view of an example of a coil of the present disclosure.

### DETAILED DESCRIPTION

This disclosure describes stators for electrical motors with an increased amount of coil wire conductor (which is typically but not necessarily copper) present in the stator slots. The stator has formed coils (either on bobbins or not) which can more fully fill a shoeless tapered slot. In some examples, at least half of the coils are formed with a tapered wire distribution. None, some, or all of the coils can have some curve or taper to them. The tapered coils can be inserted onto every other tooth before the remaining coils are inserted. In some examples, half the coils are tapered and the remaining coils can have an approximately rectangular wire distribution, which can be slid onto the remaining teeth, into the approximately rectangular gap left after the tapered coils have been inserted. This allows for less wasted area or volume of the tapered slot, yielding higher volumes of wire conductor in each slot, thus minimizing the power dissipated in the wire.

There are a wide variety of shapes of formed coils which fall under this disclosure. One distinguishing characteristic is that the formed coils may have a generally complementary border between coils, thus minimizing slot area that is empty of wire conductor. A complementary border for adjacent coils with straight borders would mean that the edges of the coils were generally parallel. If the coils have curved borders, a complementary border would mean that the coils were offset and non-intersecting over the span contained within the slot. Further, the coils can only be inserted in the sequence wherein coils on a second tooth must be inserted after the coils for the first and third tooth are already in place.

In an additional feature, if bobbins are used to hold the coil shape there may be a use for wire placement other than the common orthocylic (honeycomb) pattern. If two or more turns on the bottom layer are spaced farther apart than just touching (where in orthocyclic windings the turns on the bottom layer touch one another), the layer above the bottom layer will not sit as far away from the bobbin surface in the region where the windings are spaced farther apart. Short, upwardly-protruding dividers may be added to the bobbin to force the lowest layer wire into the desired no-touching positions. This allows the outer surface of the coil to be contoured into a particular desirable shape that can help to increase the volume of copper in the slots.

Benefits of the present disclosure include that it allows for assembly which is less complex than winding directly on the stator, and accomplishes higher copper (i.e., wire) fill factors. The first benefit can reduce labor costs, sources of rejects and/or the cost of coil winding machines, while the higher copper fill factor reduces power dissipated in windings as heat relative to a motor with lower fill factor, all else being equal.

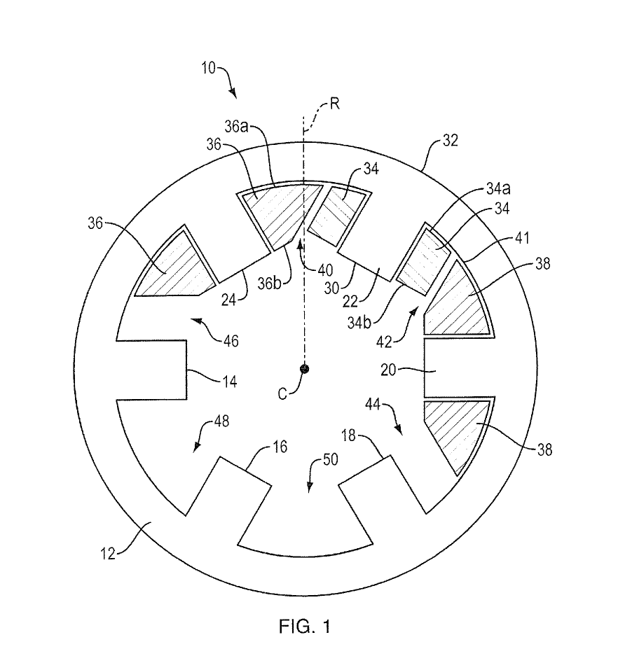

The objects, features and advantages of the present disclosure can be better understood with reference to the enclosed drawings. FIG. 1 is a schematic, partial, cross sectional view of a stator 10 for a stator wound electrical motor in which windings are located on the stator as opposed to the rotor. The motor would include a rotor which would typically be of a known configuration and so is not shown in the drawings. This disclosure is not limited to any type of motor or any type of rotor. For example, the motor could be a permanent magnet motor, an induction motor, a switched reluctance motor or other know motors having coils wound around stator pole teeth. The rotor used with the stator could be a rotor having permanent magnets, or magnetically susceptible steel, or a combination of both. Stator 10 is typically symmetric about its central longitudinal axis C (which goes into and out of the page). Stator 10 projects into the paper a distance referred to as the stator length. Stators according to the present disclosure are not limited in the stator lengths used.

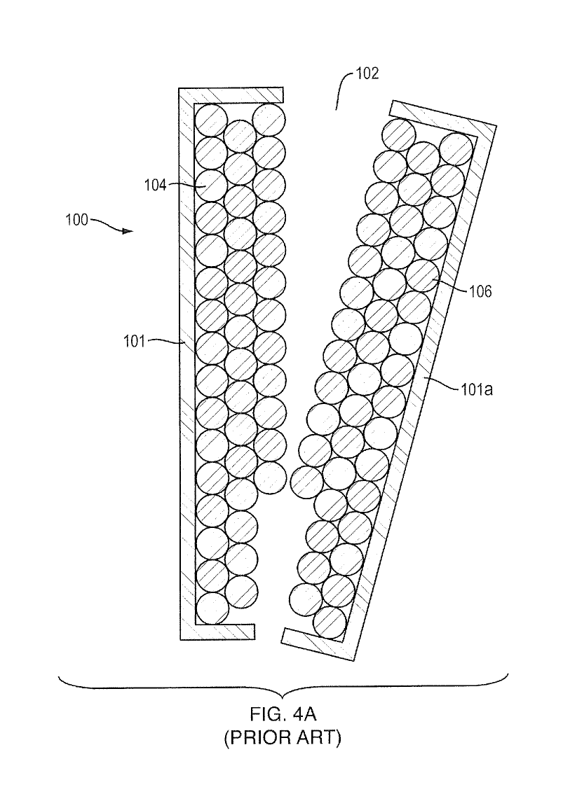

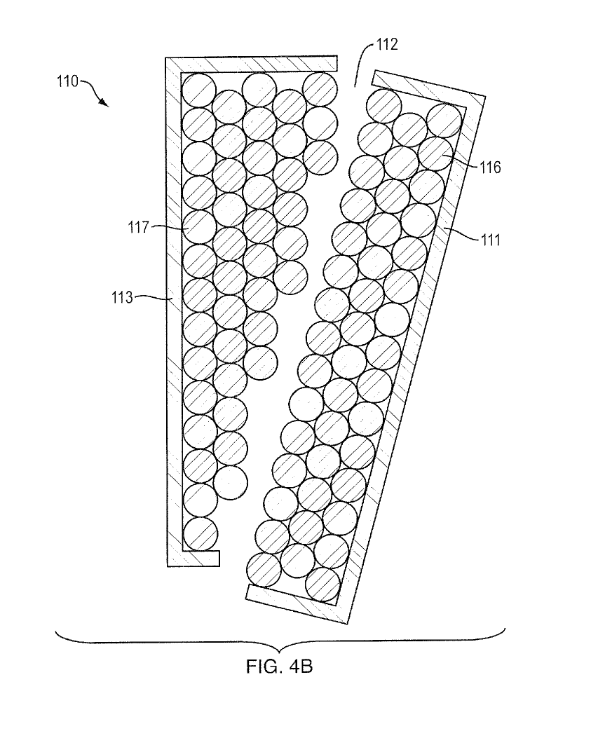

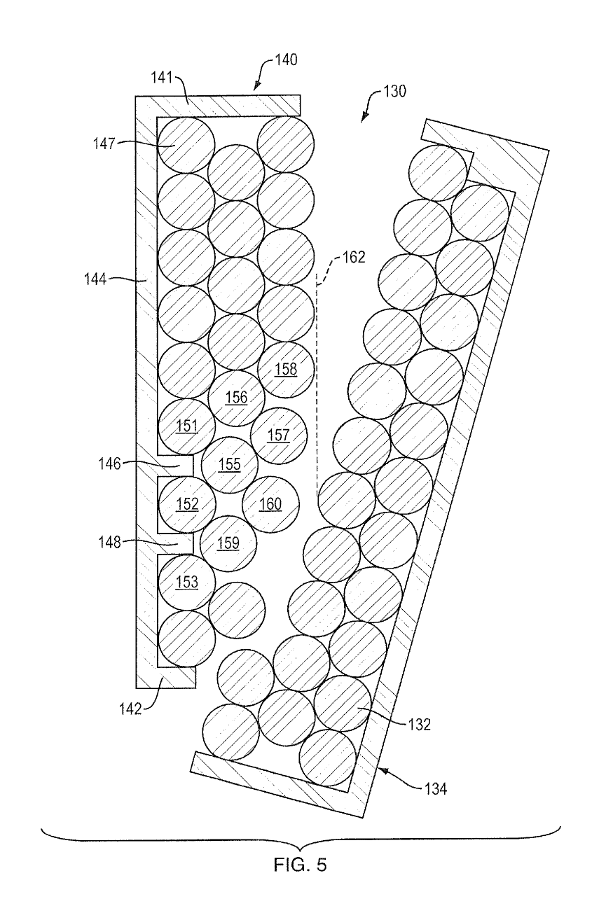

Stator 10 comprises stator ring 12 that has a number of inwardly directed teeth 14, 16, 18, 20, 22 and 24 spaced around its inner periphery, where inwardly directed teeth lie along stator radii and have their free distal ends closer to center C than are the ends that are closer to OD 32. There can be fewer than or more than the number of teeth shown, and the teeth can have different shapes and configurations than those shown in the drawings. FIG. 1 is meant to illustrate the disclosure rather than be limiting of it. The innermost part of the teeth (for example inner surface 30 of tooth 22) defines the inside diameter (ID) of stator ring 12. Stator ring 12 has an outside diameter (OD) 32. Stator ring 12 also has a number of inter-tooth slots 40, 42, 44, 46, 48 and 50 between the teeth. The teeth and slots alternate around the inner circumference of stator ring 12 as is common with stators of the type that are wound with electrical coils. The electrical coils are located in the slots. At least some (and preferably all) of the coils are wound around only a single tooth. Since the coils are wound around a tooth, the turns will occupy adjacent slots (for the case where a coil is placed around a single tooth). At a minimum, windings of a single coil will be located in at least two slots. The coil windings are schematically depicted by cross-hatching in FIGS. 1 and 3, while in FIGS. 4A, 4B and 5 the windings are depicted more like actual wires with circular cross-sections.

In FIG. 1 only some of the coils are shown so as to clearly delineate certain features of the disclosure. In most cases there would be a portion of two adjacent coils in each of the slots. For example, in the present case, coil 34 surrounds tooth 22 and coil 36 surrounds tooth 24. The portion of coil 34 in a slot has a generally rectangular cross-sectional shape, as shown. Coil 34 has an outermost surface or portion 34a that sits near or against the back 41 of slot 42 and has an innermost surface or portion 34b that is closest to the ID 30 of stator ring 12. In contrast, the portion of coil 36 in a slot has a generally trapezoidal cross sectional shape, as shown. Coil 38 can have the same shape as coil 36. This is not a requirement but will generally be true. For example, a coil could be wound on a bobbin that was not symmetric such that the coil cross section in one slot on one side of the tooth would be different from the same coil's cross section in the adjacent slot. For example, protrusions from the bobbin on opposite sides of the coil might not be the same.

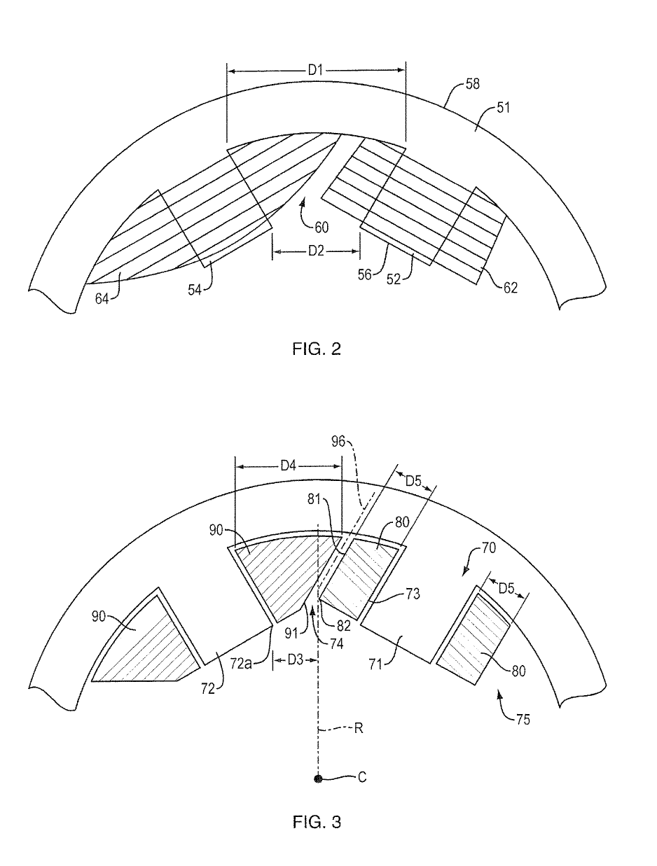

As can be seen by looking at the coil configurations in slots 40 and 42, the parts of the coils in each slot are nested such that at least part of one coil overlies or overhangs at least part of another coil along a radius R of stator 10. Thus, the stator radius R which touches the part of coil 34 that is closest to tooth 24, also intersects coil 36. This aspect is shown in more detail and described in more detail relative to FIGS. 2 and 3. Such nesting of the coils allows most of the volume of a slot to be filled with windings, which as described above minimizes the power dissipated in the windings and can increase the force or torque output of the motor that uses the stator. When the coils are placed over the teeth, coils 36 and 38 are first placed over teeth 24 and 20. This leaves a generally rectangular space in each of slots 40 and 42 that can then be mostly filled when coil 34 is then placed over tooth 22. Coil 34 cannot be placed on its tooth first because widest portion 36a of coil 36 is wider than the remaining space at the entrance to slot 40.

FIG. 2 illustrates another example of the disclosure that also has a complementary or matching border between adjacent coils in a slot but with none of the coils being generally rectangular in cross section as was the case in FIG. 1. FIG. 2 illustrates a part of stator 58 with stator ring 51 and spaced teeth 54 and 56 with slot 60 between these teeth. Coil 62 surrounds tooth 52 and coil 64 surrounds tooth 54. The coils are illustrated in a highly schematic manner as the particular coil shape and the wire size and number of turns and winding scheme can be varied within the scope of the present disclosure. Preferably but not necessarily each of the coils of any particular stator occupies about the same amount of volume as the other coils, and/or includes the same number of turns as the other coils. Coil 62 in this case has a generally trapezoidal cross-section but unlike coils 36 and 38 of FIG. 1 is inwardly tapered toward the stator OD rather than tapered toward the stator ID. Note also that outer surface (i.e., the outer perimeter) of coil 62, and indeed other coils of the present disclosure, need not be straight but could be curvilinear, for example as shown by coil 64 which has a generally dome shape with an opening in the center for the stator tooth such that its outer edge is offset from and does not intersect (i.e., complements) the outer edge of coil 62 in slot 60.

FIG. 2 also illustrates other features of the present disclosure. For reference purposes in this disclosure, in a wound stator such as disclosed herein, the slot has width, depth, and length. Length is into the page. Depth is in the radial direction of the stator (e.g., along radius R, FIG. 1). Width is in the circumferential direction of the stator. The coil (and the bobbin, when a bobbin is present) has a width, height, and length. Length is into the page. Width is in the direction of the axis around which the coil is wound, so as you are winding the first layer on a coil, you are making the coil wider. As you add a second layer, you are increasing the coil's height in a slot (e.g., the height of coil 80 in slot 74, FIG. 3, is dimension D5). Also, distance D2 is the width of the inner opening of slot 60 (closest to the stator ID) while distance D1 is the width of the outermost portion of slot 60 (closest to the stator OD). In the present case, the largest height of both coils in slot 60, taken together, is larger than dimension D2. And, neither of coils 62 and 64 can have a height in slot 60 greater than dimension D2. However, since the slot widens going towards the OD, the coils can still fit into the slot so long as they are inserted in a particular order and their heights at the back of the slot, taken together, are less than dimension D. In the present case, coil 64 would be inserted first before coil 62 was inserted.

FIG. 3 is a more detailed enlarged representation of an arrangement of stator 70 that is similar to that shown in FIG. 1. Spaced teeth 71 and 72 are separated by slot 74. Coil 80 is located over tooth 71 and coil 90 is located over tooth 72. The cross section of coil 80 in a slot is generally rectangular while the cross section of coil 90 in a slot is generally trapezoidal. Features of the present disclosure that are illustrated in FIG. 3 may be understood with reference to dimension D3 which is the distance between the innermost (i.e., closest to stator center C) height at corner 82 of coil 80 (projected along radius R) to the innermost corner 72a of tooth 72 on the side that borders slot 74. Dimension D4 is the greatest height of coil 90 in slot 74. Dimension D5 is the height of coil 80 in slot 74. Since the height of coil 80 is the same in both slots that it occupies, its height in slot 75 is also D5. In the present case, dimensions D4 and D5 taken together are larger than the opening of slot 74 (labeled D2 in FIG. 2). Further, radius R which touches corner 82 of coil 80 intersects coil 90. Still further, dimension D3 is less than dimension D4, which then requires that one coil (coil 90) always be inserted before the other (coil 80). Another way to define the arrangement of coils in slot 74 is that line 96 which is generally parallel to both the outside edge 81 of coil 80 and the outside edge 91 of coil 90, is also generally parallel to surface 73 of tooth 71 that defines one side of slot 74.

FIG. 4A illustrates prior art windings 100 in a single slot, where coil 104 is wound on bobbin 101 and coil 106 is wound on bobbin 101a. Coils 104 and 106 are identical, orthocyclically wound, and have generally rectangular cross-sections. As can be seen, a substantial space 102 is left unfilled with conductor. In contrast, FIG. 4B shows windings 110 of the present disclosure in a single slot, where generally rectangular coil 116 is wound on bobbin 111 and generally trapezoidal coil 117 is wound on bobbin 113. Coils 116 and 117 are formed according to this disclosure and together fill the slot except for smaller empty space 112. FIG. 4B also illustrates two coils, each with the same number of turns and that each occupy about the same amount of volume in a slot. Coils 114 and 116 are orthocyclically wound in this case, but they need not be. Also illustrated are complementary coil shapes where the outer surfaces of the two coils are generally parallel within the slot. Coils 116 and 117 are not exactly parallel in the drawing because of the discrete nature of the turns and small number of layers. The smaller the diameter of wire used and the more layers available, the smoother the border curves would appear. Note that these coils could also be wound without bobbins. Note that in FIGS. 4A and 4B the bobbins fill the slot between two teeth; the stator ring and teeth are not shown simply for the sake of clarity as to the coil configuration.

FIG. 5 details windings 130, which are one non-limiting example of coils wound according to this disclosure, wound on separate bobbins and where the coils have the same number of turns and fill much of the slot in which the bobbins would be located. Like FIG. 4, the stator ring and teeth that define the slot in which bobbins 134 and 140 are located are not shown, for the sake of clarity. Coil 132 is orthocyclically wound on bobbin 134. Coil 147 is non-orthocyclically wound on bobbin 140. Bobbin 140 has inner or lower wall 144 on which the wire is wound, and end, radial, wire-constraining walls 141 and 142. Short vertical dividers or walls 146 and 148 project upwardly from lower wall 144. Dividers 146 and 148 may be vertical relative to wall 144, as shown, but need not be vertical. Dividers 146 and 148 serve to separate wires 151, 152 and 153 so as to allow overlying wires 155 and 159 to sit closer to the bobbin lower winding surface (wall 144) than they would otherwise (compare their height relative to wall 144 to the height of orthocyclically wound wire 156). This causes overlying wires 157 and 160 to also sit lower than orthocyclically wound wire 158 (line 162 indicates the height that coil 147 would have if not for dividers 146 and 148). As can be seen, an arrangement in which short dividers are placed between some windings can alter the outer shape of a coil. The quantity of, location of, height of, shape of and thickness of such dividers can be varied as desired to create a desired coil cross-sectional shape. In this case, bobbin 141 would need to be inserted into the slot before bobbin 134.

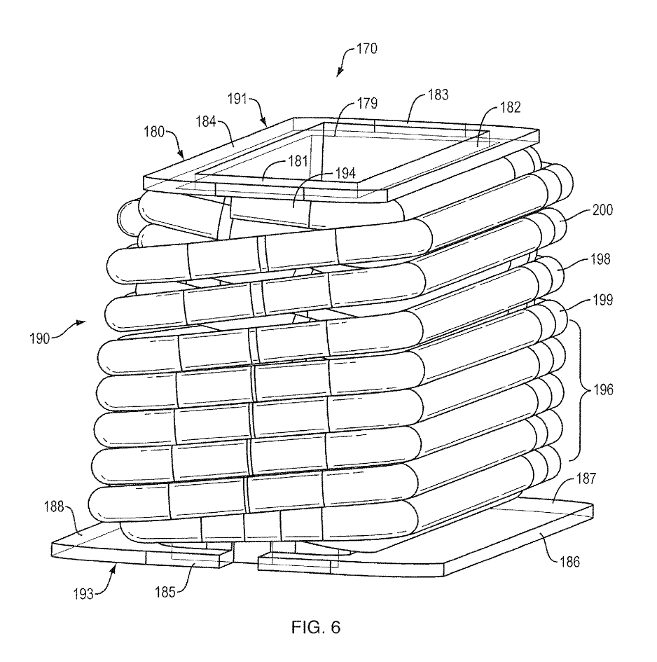

FIG. 6 is a perspective view of an example of a bobbin/coil set 170 of the present disclosure. Bobbin/coil set 170 comprises wire coil 190 wound on bobbin 180. Bobbin 180 has four-sided generally rectangular inner wall 179 that is sized and shaped to fit over a rectangular tooth (not shown). Wire 190 is wound on wall 179, beginning at point 194. Bobbin 180 also includes four-sided end, radial, wire-constraining wall 191 comprising wall sections 181-184 at one end (which will be the inner end closest to the stator ID) and four-sided end, radial, wire-constraining wall 193 comprising wall sections 185-188 at the other end (which will be closest to the stator OD). The drawing depicts two layers of wire but there could be greater than or less than this. The wire is wound around wall 179 in a counter-clockwise fashion (looking down from the top in the direction of arrow 170) and moves down from wall section 181 to wall section 185. The second wire layer overlies the first wire layer and is wound from wall section 185 back up to wall section 181. Since the orientation of the wires in the two layers changes (as shown), on one side of the coil the wires must cross-over one another rather than remaining parallel. In this case, the crossover is placed on the side between wall sections 181 and 185, while on the other three sides the wires remain parallel and nested. The sides of the coil between wall sections 182 and 186, and between wall sections 184 and 188, lie in two adjacent slots. The height of the coil in the crossover region is equal to two times the wire thickness, whereas the height on the other three sides is less two times the wire thickness because the overlying wires lie over the intersection of two underlying wires. Placing the crossover region outside of slot thus allows a greater volume of wire conductor in the slot.

FIG. 6 also shows a coil wound in a manner similar to that of FIG. 5, where some wires are slightly separated by short dividers in the bobbin (not shown in FIG. 6). For example, wire 198 is spaced from wire 199, and wire 200 is spaced from wire 198 (because the wires that underlie wires 198-200 are themselves spaced apart). In contrast, the wires of wire set 196 are orthocyclically wound. Wires 198 and 200 will thus sit lower than the wires of wire set 196.

A number of implementations have been described. Nevertheless, it will be understood that additional modifications may be made without departing from the scope of the inventive concepts described herein, and, accordingly, other embodiments are within the scope of the following claims.

What is claimed is:

1. A stator for a stator-wound electrical motor, comprising:
a stator ring having an inside diameter (ID) and an outside diameter (OD), the stator ring comprising a series of spaced, inwardly-directed stator teeth, and inter-tooth slots between adjacent teeth, where the teeth and slots are arranged around the ID of the stator ring, and where at least some of the slots are inwardly tapered, such that the tapered slots are wider nearer the stator ring OD than they are nearer the stator ring ID; and
a plurality of electrical coils that are partially located in the slots, where at least some of the coils surround a single tooth and occupy some of the space of both slots that border the single tooth such that in at least one of the tapered slots there are portions of two adjacent coils, and where these two adjacent coils are constructed and arranged such that in order to insert both such adjacent coils on their teeth without altering either coil, one particular coil of the two adjacent coils must be inserted before the other coil.

2. The stator of claim 1 wherein the two adjacent coils are further constructed and arranged such that the dimension of the greatest height of the part of one of the two adjacent coils that is in the tapered slot plus the dimension of the greatest height of the part of the other of the two adjacent coils that is in the tapered slot, is greater than the dimension of the width of the tapered slot nearest the stator ring ID.

3. The stator of claim 1 wherein the portion of one of the two adjacent coils in a particular slot has a generally rectangular cross-sectional shape, and the portion of the other of the two adjacent coils in the particular slot has a generally trapezoidal cross-sectional shape.

4. The stator of claim 3 wherein the portion of the other of the two adjacent coils in the particular slot that has a generally trapezoidal cross-sectional shape has a greater height closer to the stator ring OD than it does closer to the stator ring ID.

5. The stator of claim 1 wherein each of the two adjacent coils occupies about the same amount of volume in a particular slot as the other.

6. The stator of claim 1 wherein each of the two adjacent coils comprises about the same number of turns of wire as the other.

7. The stator of claim 1 wherein at least some of the coils are wound on bobbins, and wherein at least one such bobbin comprises a lower wall on which the coil wire is wound, and one or more short dividers that project upwardly from the lower wall, where the short dividers have a height that is less than the wire diameter, and serve to separate wires that are adjacent to such dividers, so as to allow overlying wires to sit closer to the bobbin lower wall than they would if such wires were orthocyclically wound.

8. The stator of claim 7 wherein the short dividers are vertical.

9. The stator of claim 1 wherein at least a first coil has a generally rectangular circumferential shape with four sides wherein first and second generally parallel sides lie in two adjacent slots and third and fourth generally parallel sides do not lie in slots, and where the first coil comprises at least two layers of wire, wherein on one of the third and fourth sides the wires of adjacent layers cross-over one another such that the height of the coil on that side is equal to the wire diameter times the number of wire layers, and wherein on each of the other three sides the wires of adjacent layers are generally parallel and the height of the coil on these sides is less than the wire diameter times the number of wire layers.

10. The stator of claim 1 wherein the portion of one of the two adjacent coils in a particular slot has a generally domed cross-sectional shape, and the portion of the other of the two adjacent coils in the particular slot has a generally trapezoidal cross-sectional shape.

11. The stator of claim 10 wherein the portion of the one of the two adjacent coils in the particular slot that has a generally domed cross-sectional shape has a greater height closer to the stator ring OD than it does closer to the stator ring ID.

12. The stator of claim 11 wherein the portion of the other of the two adjacent coils in the particular slot that has a generally trapezoidal cross-sectional shape has a greater height closer to the stator ring ID than it does closer to the stator ring OD.

13. The stator of claim 1 wherein the two adjacent coils are further constructed and arranged such that their free edges that face one another in a slot are generally complementary.

14. The stator of claim 13 wherein the free edges of the two adjacent coils are generally straight.

15. The stator of claim 1 wherein in at least some of the coils there are multiple layers of wires that have a length in each layer, with a first layer closest to a stator tooth and a second layer directly on top of the first layer, where at least some adjacent wires in the first layer are spaced apart and so do not touch one another over at least some of their length in the first layer.

16. The stator of claim 15, wherein at least some adjacent wires in the second layer are spaced apart and so do not touch one another over at least some of their length in the second layer.

17. A stator for a stator-wound electrical motor, comprising:
a stator ring having an inside diameter (ID) and an outside diameter (OD), the stator ring comprising a series of spaced, inwardly-directed stator teeth, and inter-tooth slots between adjacent teeth, where the teeth and slots are arranged around the ID of the stator ring, and where at least some of the slots are inwardly tapered, such that the tapered slots are wider nearer the stator ring OD than they are nearer the stator ring ID; and
a plurality of electrical coils that are partially located in the slots, where at least some of the coils surround a single tooth and occupy some of the space of both slots that border the single tooth such that in at least some of the tapered slots there are portions of two adjacent coils, and wherein these two adjacent coils are constructed and arranged such that the dimension of the greatest height of the part of one of the two adjacent coils that is in the tapered slot plus the dimension of the greatest height of the part of the other of the two adjacent coils that is in the tapered slot, is greater than the dimension of the width of the tapered slot nearest the stator ring ID.

18. A stator for a stator-wound electrical motor, comprising:
a stator ring having an inside diameter (ID) and an outside diameter (OD), the stator ring comprising a series of spaced, inwardly-directed stator teeth, and inter-tooth slots between adjacent teeth, where the teeth and slots are arranged around the ID of the stator ring, and where at least some of the slots are inwardly tapered, such that the tapered slots are wider nearer the stator ring OD than they are nearer the stator ring ID; and
a plurality of electrical coils that are partially located in the slots, where at least some of the coils surround a single tooth and occupy some of the space of both slots that border the single tooth such that in at least some of the tapered slots there are portions of two adjacent coils, and wherein at least some of the coils are wound on bobbins, and wherein at least one such bobbin comprises a lower wall on which the coil wire is wound, and one or more short dividers that project upwardly from the lower wall, where the short dividers have a height that is less than the wire diameter, and serve to separate wires that are adjacent to such dividers, so as to allow overlying wires to sit closer to the bobbin lower wall than they would if such wires were orthocyclically wound.

19. The stator of claim 18 wherein the short dividers are generally vertical.

20. The stator of claim 18 wherein the two adjacent coils are constructed and arranged such that the dimension of the greatest height of the part of one of the two adjacent coils that is in the tapered slot plus the dimension of the greatest height of the part of the other of the two adjacent coils that is in the same tapered slot, is greater than the dimension of the width of the tapered slot nearest the stator ring ID.
